(19) United States
(12) Patent Application Publication
(10) Pub. No.: US 2001/0018344 A1
(43) Pub. Date: Aug. 30, 2001

(54) Method and devices for determining movement data of a mobile station

(75) Inventors: Juha Tuomo Tervo, Bochum (DE); Jens Konig, Bochum (DE); Klaus Kunze, Bochum (DE); Sedat Karahan, Bochum (DE)

Correspondence Address: Clarence A. Green, PERMAN & GREEN, LLP, 425 Post Road, Fairfield, CT, 06430, US

(73) Assignee: Nokia Mobile Phones Ltd.

(21) Appl. No.: 09/772,129

(22) Filed: Jan. 29, 2001

(30) Foreign Application Priority Data
Jan. 31, 2000 (DE) 10004061.6

(51) Int. Cl. H04Q 7/20

(52) U.S. Cl. 455/435; 455/456; 455/525

(57) ABSTRACT

Movement data of a mobile station (15) which is associated with a mobile radio network are determined by storing, for a plurality of base stations (23, 24, 25, . . . ) which are associated with the mobile radio network and which successively supply the mobile station (15) as it moves, at least the location information (Z; X, Y) which is associated with the base stations, and deriving the movement data from a sequence of stored location information in order to be able to call from a database traffic-related information by means of the movement data.

The invention relates to a method for determining movement data of a mobile station which is associated with a mobile radio network, according to claim 1, and to a mobile station or a mobile radio network for carrying out the method.

Movement data are generally understood to be data which describe the movement of a mobile station, that is to say data which describe a path covered by the mobile station, or such data which specify the direction of movement or the velocity of the mobile station and the like. After such movement data have been determined, information can be transmitted to the mobile station either automatically or selectively on request, from a service provider, for example. This information may be traffic information from a central database, for example information from devices along a route, for instance information relating to filling stations, hotels, restaurants or tourist attractions, etc. However, it is also possible, for example, to use the movement data to coordinate the deployment of rescue services which are equipped with mobile stations.

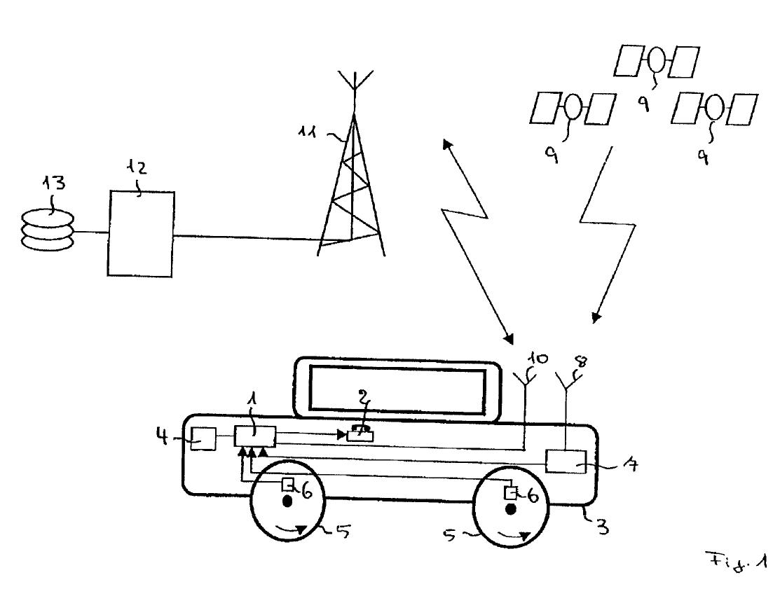

It is generally known to determine movement data of the aforesaid type by using navigation systems such as are shown in FIG. 1. A mobile station 1 in the form of a car telephone with receiver storage bracket 2 is installed here in a motor vehicle 3. In addition, a direction sensor 4 or gyrometer, having wheel sensors 6 which interact with wheels 5 of the motor vehicle 3 and a GPS satellite receiver 7 which is installed in the motor vehicle 3 are connected to the mobile station 1. The satellite receiver 7 receives, via its antenna 8, position signals which are emitted by GPS satellites 9, and is capable of using these position signals to determine its geographic coordinates on the ground and feed them to the mobile station 1. The mobile station 1 can then enter into contact with a service provider 12 by means of its antenna 10 and a base station 11, in order to receive, from said service provider 12, information relating to the movement data of the motor vehicle 3 from a database 13.

However, it is disadvantageous that, in addition to the mobile station, relatively extensive further devices such as GPS satellite receivers, direction sensors and wheel sensors are necessary to be able to determine movement data at all. This not only makes the overall cost of the communications system higher but said system also becomes more susceptible to faults.

WO 98/58459 discloses a method and a device for providing location-related information to mobile radio subscribers, at least one information control centre being provided with which the mobile radio subscriber can communicate via the mobile radio network. The mobile radio subscriber can select a predefined call number and set up a communications link to the information control centre, the location information present in the mobile radio network being appended, by means of the base station which is supplying the mobile station at that moment, to the call number selected by the mobile radio subscriber, as a suffix number, with the result that this expanded call number is used to connect through the link to the information control centre and the latter can transfer location-related information to the mobile radio subscriber by means of the suffix number.

However, if information is not desired for a specific area but rather information is desired which is related to the direction of travel, a direction of travel must be entered or a destination defined.

The invention is based on the object of specifying a further method and further devices for determining movement data of a mobile station in a simpler way.

The method solution of the object set is disclosed in claim 1. In contrast, the device solutions of the object set are given in claims 13 and 14. Advantageous developments of the invention can be found in the respective dependent claims.

In the method according to the invention for determining movement data of a mobile station which is associated with a mobile radio network, for a plurality of base stations which are associated with the mobile radio network and which successively supply the mobile station as it moves, at least the location information which is associated with the base stations is stored and the movement data is derived from a sequence of stored location information. In order to determine the movement data, it is therefore no longer necessary to use a complex GPS system, but instead it is possible to determine said data directly using components of the terrestrial mobile radio network, for example at the service provider or in the mobile station itself. This simplifies and reduces the cost of the communications system considerably.

According to one refinement of the invention, the code numbers of the radio cells which are associated with the respective base stations, or the geographic coordinates of the respective base stations, can be stored as location information. When the mobile station is communicating with the respective base stations, the mobile radio network is always aware of the code numbers or geographic coordinates of the base station which is supplying the mobile station at that particular time so that such a sequence of code numbers or geographic coordinates can easily be buffered in order to determine the movement data.

Thus, for example a stored sequence of location information can be used, if appropriate making use of a reception field strength of a signal transmitted between the mobile station and the respective base station, to determine coordinates of a road which represent movement data. If a greater degree of precision is desired for the coordinates determined for the road, it would be possible, if appropriate, to use in addition a so-called “map matching method” in which the road coordinates which are initially determined are reconciled with map information present in electronic form. It would also be possible to carry out propagation time measurements of electrical signals between the mobile station and various base stations so that, in addition, better coordinates of the mobile station are obtained (for example it would be possible to use a so-called timing advance method).

However, a direction of movement of the mobile station can also be determined as movement data from the stored sequence of location information, again if appropriate making use of a reception field strength of a signal transmitted between the mobile station and base station. To do this, simply the position of the radio cells associated with the location information is determined and the future direction of movement of the mobile station is inferred from the geographic profile of the adjoining radio cells. This can be carried out, for example, by determining an average directional vector by means of a number of previous connecting vectors between respectively adjacent base stations.

However, a velocity of the mobile station can also be determined as movement data from the stored sequence of location information and associated times at which the mobile station is supplied by a respective base station. This information or velocity can be used, for example, to determine whether the mobile station is installed in a motor vehicle travelling on a road, for example, or, if appropriate, on which type of road the motor vehicle is travelling, or whether the mobile station is merely being carried by a user who is walking along. To this extent, the “velocity” information can also contribute to more accurate determining of positions in respective radio cells, with the result that road types can be possibly excluded or selected with priority. The “velocity” information can, however, also provide information on the behaviour over time of a user carrying the mobile station, with the result that in this respect also it is possible to conceive, for example, a better way of coordinating rescue services, for example.

In all the mentioned cases, the movement data can be conceived of as selection criteria as to which information should be, for example, transmitted to the mobile station automatically, or on express request, from a service provider. This information could thus be selected in terms of its direction on the basis of the movement data and/or could be oriented in terms of roads and directions. However, it could also be selected in terms of velocity.

The location information itself and/or the times and/or the reception field strengths could be stored separately from the mobile station in a memory, for example at the service provider's premises. The movement data from the previously determined variables could also be calculated and stored there. A mobile radio subscriber then merely needs to call the movement-data-selected information using the mobile station.

It would, however, also be possible to buffer the location information and/or the times and/or the reception field strengths directly in the mobile station and transmit it to the service provider only when necessary, said service provider then extracting therefrom the movement data, and ultimately using this movement data to extract the relevant information from the database and transmit it to the mobile station.

It is possible to provide the mobile station with an appropriate switching device for transmitting the stored sequence of location information, times or field strengths to the central station or to a service provider. Ultimately, the mobile station could also itself be capable of determining movement data of the mobile station from the stored sequence of location information, times or field strengths.

An exemplary embodiment of the invention is described below in more detail with reference to the drawing, in which:

FIG. 1 shows a device for determining movement data by means of satellite navigation;

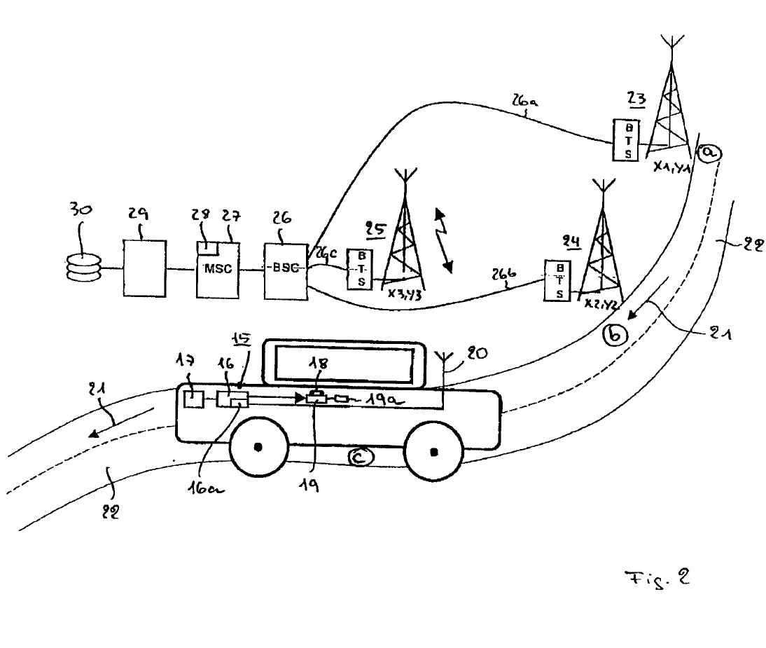

FIG. 2 shows a device for determining movement data using a terrestrial mobile radio network;

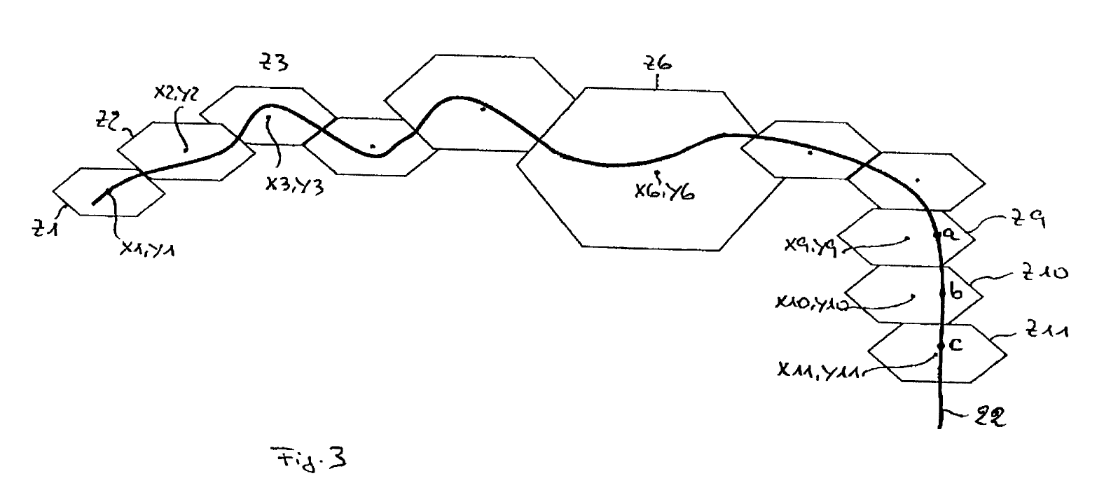

FIG. 3 shows a sequence of radio cells through which a motor vehicle successively travels; and

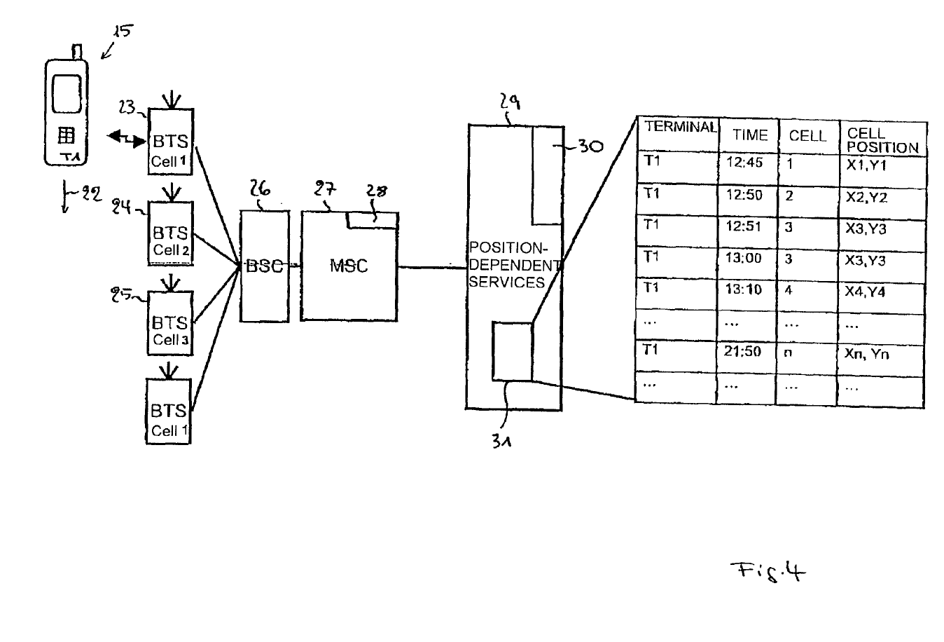

FIG. 4 shows a mobile radio network according to the invention.

FIG. 2 shows a mobile station 15 which is installed in a motor vehicle 14 and is composed of a car telephone 16 with movement-data determining store 16a to which a data memory 17, a receiver 18 with a storage rack 19 and an antenna 20 are connected. In addition, a change-over switch 19a is connected to the car telephone 16. The motor vehicle 14 moves along a road 22 in the direction of the arrow 21. The mobile station 15 could also be provided in the form of a mobile phone which is carried along in the motor vehicle 14, but it could also be carried directly by a user who is walking along the road 22.

A plurality of base stations which are locationally fixed and of which, for example, only three are shown are associated with a mobile radio network shown in FIG. 2. These are the base stations 23, 24 and 25. In each case, a plurality of the base stations are connected to a base station controller 26, for example via lines 26a, 26b and 26c. The base station controller 26 is connected to a switching centre 27 which can serve a plurality of base station controllers 26. A mass storage device 28, which, inter alia, stores the geographic coordinates of the respective base stations 23, 24 and 25 and, if appropriate, stores the code numbers of the radio cells associated with the respective base stations 23, 24 and 25, is associated with the switching centre 27.

Finally, a central processing unit 29, which is associated, for example, with a service provider, is connected to the switching station 27. A database 30 is associated with this central processing unit 29.

If the motor vehicle 14 moves along the road 22 in the direction of the arrow 21 starting from the point a to the point b and subsequently to the point c, the switched-on mobile station 15 in the motor vehicle 14 is successively supplied by the base stations 23, 24 and 25. The mobile station 15 therefore has successive communications connections to the base stations 23, 24 and 25, and, during such a connection, automatically receives information relating to the code numbers of the radio cells which are being travelled through at a particular time, or relating to the geographic coordinates of the base stations associated with these radio cells. These code numbers or geographic coordinates are stored here as a data sequence in the data memory 17 of the mobile station 15. The data memory 17 can also store times at which a sufficiently good radio link has been set up again with the nearest base station whenever one of the radio cells has been travelled through. Furthermore, the mobile station 15 is also capable of carrying out measurements of the electrical field strength of received signals which are transmitted by the respective base stations. These field strength profiles can also be stored in the data memory 17.

If the driver of the motor vehicle 14 requests, at a specific time, traffic information relating to him at, for example, the location c from the service provider, for example by activating the switching device 19a, the data stored in the data memory 17 (location information of the base stations, times, field strengths) are automatically transmitted to the service provider and fed there into the central processing unit 29, where they are buffered. The central processing unit 29 then calculates movement data of the motor vehicle 14 from the buffered data.

Thus, said central processing unit 29 can determine, for example, the direction of travel of the motor vehicle 14 from the location information of the base stations associated with the radio cells travelled through, in that said central processing unit 29 forms, for example, from a plurality of location vectors connecting the positions of base stations of radio cells successively travelled through, an average directional vector which specifies an assumed, future direction of travel of the motor vehicle 14. The central processing unit 29 or service provider then searches only for traffic information which applies to this direction from the database 30 and transmits that information to the mobile station 15 via the base station which is supplying the mobile station 15 at that particular time. The direction-related information can then be conveyed to the driver of the motor vehicle 14 in some suitable way, for example audibly or visually.

The central processing unit 29 of the service provider can, however, also use the data received from the data memory 17 to calculate other movement data of the motor vehicle 14, for example the actual geographic position of the motor vehicle 14 if additional comparisons are made with existing road maps. Here too, the previously mentioned “map matching method” may be used. In addition, by comparing the measured field strength with actually present field strengths in accordance with a field strength map stored at the service provider it is also possible to infer more satisfactorily the actual geographic position of the motor vehicle 14, with the result that the movement data can also be refined in this way. As a function of the movement data obtained in this way, the service provider then in turn supplies appropriate traffic information back to the motor vehicle, if appropriate on request.

FIG. 3 shows the course of the road 22 through a plurality of radio cells Z1, Z2, . . . , Z11, . . . . The location coordinates of the respective base stations are designated by X1, Y1; . . . ; X11, Y11; . . . . If the location information Z9; X9, Y9 and Z10; X10, Y10 and Z11; X11, Y11 are respectively buffered at, for example, the points a, b and c (see FIG. 2), said buffering taking place specifically in the data memory 17, and if direction-selective traffic information is desired by the driver of the motor vehicle 14 at the point c, this location information is transmitted to the service provider and the latter calculates, from the position vectors connecting the points a and b or b and c, an average directional vector, by means of which directional vector the traffic information relating to this direction is read out of the database 30 and transmitted back to the motor vehicle 14. If, furthermore, the traffic information is desired for just one specific road, for example for the road 22, it would be possible to determine the position of the road 22 by means, for example, of the electrical field strength values which are also transmitted to the service provider, as a result of which it would then be possible to make more accurate selections of the information stored in the database 30.

However, the movement data could also be determined in a device 16a of the mobile station 16 and only after that transmitted to the service provider.

FIG. 4 shows a second embodiment of the invention. Here, elements identical to those in FIGS. 2 and 3 are provided with the same reference symbols. However, in contrast to FIG. 2, the location information, that is to say the code numbers of the respective radio cells and the geographic coordinates of the respective base stations, is stored at the service provider here, and not in the mobile station, which is represented here as a mobile phone. The mobile phone can be carried by a user when walking or carried in the motor vehicle 14.

If the mobile phone 15 moves along the route 22, whenever it is supplied by one of the base stations the location information of this base station is stored in a data memory 31 of the service provider 29. According to FIG. 4, the mobile phone 15 firstly moves through the radio cell 1 associated with the base station 23, with the result that the code number 1 of the cell 1 is stored, together with the location coordinates X1, Y1 of the associated base station, in the memory 31. In addition, the time (12.45 pm) at which a satisfactory link has been set up between the mobile station 15 and base station 23 is stored. As the mobile station 15 continues to move along the road 22, the base station 24 then takes up the function of supplying the mobile station 15 at 12.50 pm, with the result that at this time the code number 2 of the radio cell 2 is stored, along with the location coordinates X2, Y2 of the base station 24, etc. In this way, a sequence of location information is stored, in this case together with the respective times, in the memory 31. The central processing unit 29 of the service provider can then, as already mentioned, determine movement data of the mobile station 15 by means of this sequence of location information or times, with the result that information can then be selectively read out of the database 30 of the service provider on the basis of this movement data, and transmitted to the mobile station 15.

In the exemplary embodiment according to the invention, it is also possible to determine the velocity of the mobile station 15 along the road 22 if it is assumed that the mobile station 15 is moving at an average velocity because the variables of the respective radio cells and the times when the mobile station 15 enters the respective radio cells are known.

1. Method for determining movement data of a mobile station (15) which is associated with a mobile radio network and in which, for a plurality of base stations (23, 24, 25, . . . ) which are associated with the mobile radio network and which successively supply the mobile station (15) as it moves, at least the location information (Z; X, Y) which is associated with the base stations (23, 24, 25, . . . ) is stored and the movement data is derived from a sequence of stored location information (Z1; X1, Y1-Z2; X2, Y2- . . . ).

2. Method according to claim 1, characterized in that the code number of a radio cell (Z1, Z2, Z3, . . . ) which is associated with a respective base station (23, 24, 25, . . . ) is stored as location information.

3. Method according to claim 1 or 2, characterized in that the geographic coordinates (X, Y) of a respective base station are stored as location information.

4. Method according to claim 1, 2 or 3, characterized in that in addition the time at which the mobile station (15) is supplied from a respective base station from among the base stations (23, 24, 25, . . . ) is stored.

5. Method according to one of claims 1 to 4, characterized in that in addition a reception field strength of a signal transmitted between the mobile station and respective base station is stored.

6. Method according to one of claims 1 to 5, characterized in that a direction of movement of the mobile station (15) is determined as movement data from the stored sequence of location information, if appropriate making use of a reception field strength of a signal transmitted between the mobile station and base station.

7. Method according to claim 6, characterized in that the stored sequence of location information and, if appropriate, the reception field strength are used to determine coordinates of a road (22) which constitute movement data.

8. Method according to one of claims 4 to 7, characterized in that a velocity of the mobile station (15) is determined as movement data from the stored sequence of location information and the times at which the mobile station (15) has been supplied by the respective base stations (23, 24, 25, . . . ).

9. Method according to one of claims 1 to 8, characterized in that the location information and/or the times and/or the reception field strengths and/or the movement data are stored separately from the mobile station (15) in a memory (31).

10. Method according to one of claims 1 to 8, characterized in that the location information and/or the times and/or the reception field strengths and/or the movement data are stored in a memory (17) of the mobile station (15).

11. Method according to claim 10, characterized in that the location information and/or the times and/or the reception field strengths and/or the movement data are transmitted to a service provider (29) when necessary.

12. Method according to claim 9 or 11, characterized in that information which is dependent on the movement data determined is transmitted to the mobile station (15).

13. Mobile radio network having a plurality of base stations (23, 24, 25, . . . ) for supplying at least one mobile station (15), and having at least one central station (29) which is designed in such a way that, for a plurality of base stations (23, 24, 25, . . . ) which successively supply the mobile station (15) as it moves, said central station (29) stores at least the location information (Z; X, Y) associated with the base stations (23, 24, 25, . . . ) and determines movement data of the mobile station (15) from a sequence of stored location information.

14. Mobile station (15) for a mobile radio network having a plurality of base stations (23, 24, 25, . . . ), which mobile station (15) is designed in such a way that, for a plurality of base stations (23, 24, 25, . . . ) which successively supply the mobile station (15) as it moves, said mobile station (15) stores, as a sequence, at least the location information (Z, X, Y) associated with the base stations (23, 24, 25, . . . ).

15. Mobile station (15) according to claim 14, characterized by a switching device (19a) for transmitting the stored sequence of location information to a central station (29).

16. Mobile station (15) according to claim 14, characterized in that it has a determination device (16a) which determines movement data of the mobile station (15) from the stored sequence of location information.
